(19) United States
(12) Patent Application Publication
(10) Pub. No.: US 2012/0314446 A1
(43) Pub. Date: Dec. 13, 2012

(54) Backlight pad for keypad assembly

(76) Inventor: Bae Kyung JEON, Yongin-si (KR)

(21) Appl. No.: 13/136,451

(22) Filed: Aug. 2, 2011

(30) Foreign Application Priority Data
Jun. 9, 2011 (KR) 10-2011-0055790
Jun. 9, 2011 (KR) 10-2011-0055798
Jun. 17, 2011 (KR) 10-2011-0059080

(51) Int. Cl. F21V 7/04

(52) U.S. Cl. 362/602

(57) ABSTRACT

A backlight pad for a keypad assembly is provided, which can minimize power consumption of a battery through applying of a small number of light emitting elements and provide uniform light to all the button portions of the keypad. The backlight pad for a keypad assembly includes a light guide sheet on which condensing holes are penetratingly formed and light emitting element installation holes are arranged; a reflection sheet attached to a lower surface of the light guide sheet to prevent a loss of light through a lower portion of the light guide sheet, and having through-holes and light emitting element through-holes formed thereon; and light emitting elements electrically connected to the substrate and positioned in the light emitting element installation holes through the light emitting element through-holes, respectively; wherein side condensing holes are additionally formed in a body with the condensing holes that are formed in regions except for adjacent regions of the light emitting elements, and have areas which are wider than areas of the condensing holes that are formed in the adjacent regions of the light emitting elements.

### CROSS-REFERENCE TO RELATED APPLICATION

This application is based on and claims priority from Korean Patent Application Nos. 10-2011-0055790 and 10-2011-0059080 filed on Jun. 9, 2011 and Jun. 17, 2011 respectively in the Korean Intellectual Property Office, the disclosure of which is incorporated herein in its entirety by reference.

### BACKGROUND OF THE INVENTION

1. Field of the Invention

The present invention relates to a backlight pad for a keypad assembly which is installed between a keypad and a substrate to provide light to button portions of the keypad in a keypad assembly that forms an operation panel of an operation appliance such as a remote control or a mobile phone. More particularly, the present invention relates to a backlight pad for a keypad assembly which can minimize power consumption of a battery through applying of a small number of light emitting elements and provide uniform light to all the button portions of the keypad regardless of a distance between the light emitting elements and the button portions.

2. Description of the Prior Art

In general, an operation appliance such as a remote controller or a mobile phone includes various kinds of operation buttons, and these operation buttons form a keypad assembly that includes a keypad that includes a plurality of button portions, a dome switch sheet installed on a lower portion of the keypad and provided with dome switches that are positioned to correspond to the button portions, and a substrate installed on a lower portion of the dome switch sheet to generate a button operation signal according an interlocking operation of the dome switch that is caused by the pressing of the button portion.

In the case of operating a button of an operation appliance such as a remote controller or a mobile phone in the daytime or under bright illumination, there is no big problem in operating the button of the operation appliance, while in the case of operating the button of the operation appliance at night or in an environment having insufficient illumination, it is difficult for the user to perform the button operation. To cope with this, a method in which characters are printed on the button portions of the keypad with luminescent paint has been used. Recently, a keypad assembly in which a backlight pad is installed between a keypad and a substrate to discharge light through button portions of the keypad is in the limelight.

Such a backlight pad of a keypad assembly includes a light guide sheet on which circular condensing holes are penetratingly formed in positions that correspond to the button portions of the keypad and light emitting element installation holes for installing light emitting elements are arranged, the light emitting elements electrically connected to the substrate and positioned within the light emitting element installation holes to provide light to the light guide sheet, a reflection sheet attached to a lower surface of the light guide sheet to prevent a loss of the light through the lower portion of the light guide sheet, and light emitting element covers covering upper surfaces of the light emitting elements to make the light from the light emitting elements be transferred to the light guide sheet.

In the case of the keypad assembly in the related art, in order to provide maximally uniform light to a plurality of button portions provided on the keypad, a large number of light emitting elements that correspond to the number of buttons are integrally provided on the light guide sheet, and thus the power consumption becomes severe to cause frequency replacement of a battery.

If a small number of light emitting elements are integrally provided on the light guide sheet in order to overcome the above-described problem, it is difficult to obtain uniform brightness of the button portions according to the positions of the light emitting elements.

### SUMMARY OF THE INVENTION

Accordingly, the present invention has been made to solve the above-mentioned problems occurring in the prior art while advantages achieved by the prior art are maintained intact.

An embodiment of the present invention proposes a backlight pad for a keypad assembly which can minimize power consumption of a battery through applying of a small number of light emitting elements and provide uniform light to all the button portions of the keypad regardless of a distance between the light emitting elements and the button portions.

In one aspect of the present invention, there is provided a backlight pad for a keypad assembly that is installed between a keypad and a substrate in the keypad assembly to provide light to button portions of the keypad, which includes a light guide sheet on which condensing holes are penetratingly formed in positions that correspond to the button portions of the keypad and light emitting element installation holes are arranged; a reflection sheet attached to a lower surface of the light guide sheet to prevent a loss of light through a lower portion of the light guide sheet, the reflection sheet having through-holes formed in positions that correspond to the condensing holes of the light guide sheet and light emitting element through-holes arranged in positions that correspond to the light emitting element installation holes of the light guide sheet; and light emitting elements electrically connected to the substrate, and positioned in the light emitting element installation holes through the light emitting element through-holes, respectively, to provide light to the light guide sheet; wherein side condensing holes are additionally formed in a body with the condensing holes that are formed in regions except for adjacent regions of the light emitting elements, and have areas which are wider than areas of the condensing holes that are formed in the adjacent regions of the light emitting elements.

The backlight pad for a keypad assembly according to an embodiment of the present invention may further include light emitting element covers attached to the light emitting element installation holes of the light guide sheets to make the light from the light emitting elements be transferred to the light guide sheet.

The backlight pad for a keypad assembly according to an embodiment of the present invention may further include a side cover attached to a side surface of the edge of the light guide sheet to prevent a loss of the light, which is transferred through the light guide sheet, through the side surface of the edge of the light guide sheet.

The light emitting elements may be arranged to be spaced apart from each other on the center line of the light guide sheet, may be symmetrically arranged on the basis of the center line of the light guide sheet, or part of the light emitting elements may be arranged to be spaced apart from each other on the center line of the light guide sheet, while the remaining part thereof may be symmetrically arranged on the basis of the center line of the light guide sheet.

Only one side condensing hole may be formed to project to one side around the condensing hole, two side condensing holes may be formed to project at an angle of 180° with each other around the condensing hole, three side condensing holes may be formed to project at an angle of 120° with one another around the condensing hole, or four side condensing holes may be formed to project at an angle of 90° with one another around the condensing hole.

The through-hole of the reflection sheet may have an area that is smaller than an area of the condensing hole of the light guide sheet.

According to the backlight pad for a keypad assembly according to the present invention, since the side condensing holes are additionally formed in a body with the condensing holes that are formed in the regions except for the adjacent regions of the light emitting elements, and have the areas which are wider than the areas of the condensing holes that are formed in the adjacent regions of the light emitting elements, the condensing holes formed in the regions except for the adjacent regions of the light emitting elements are far apart from the light emitting elements to make less light reach the condensing holes in comparison to the adjacent regions of the light emitting elements, whereas even the light that gets out of the condensing holes is condensed into the condensing holes to be transferred to the button portions. Accordingly, uniform light can be provided to all the button portions of the keypad regardless of the distance between the light emitting elements and the button portion, and thus a smaller number of light emitting elements can be applied to minimize the power consumption of a battery.

### BRIEF DESCRIPTION OF THE DRAWINGS

The above and other objects, features and advantages of the present invention will be more apparent from the following detailed description taken in conjunction with the accompanying drawings, in which:

FIGS. 1A and 1B are cross-sectional views of a keypad assembly in which a backlight pad according to an embodiment of the present invention is installed;

FIG. 2 is a perspective view of a keypad assembly in which a backlight pad according to an embodiment of the present invention is installed;

FIG. 3 is an exploded perspective view of a keypad assembly in which a backlight pad according to an embodiment of the present invention is installed;

FIG. 4 is a partial cross-sectional view of backlight pad for a keypad assembly according to an embodiment of the present invention taken along line A-A in FIG. 2;

FIGS. 5A to 5C are views explaining the condensing principle of condensing holes that are additionally formed in a body with side condensing holes in a backlight pad for a keypad assembly according to an embodiment of the present invention;

FIG. 6 is a perspective view of a remote controller to which a backlight pad for a keypad assembly according to an embodiment of the present invention is applied; and

FIG. 7 is a perspective view of a mobile phone to which a backlight pad for a keypad assembly according to an embodiment of the present invention is applied.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

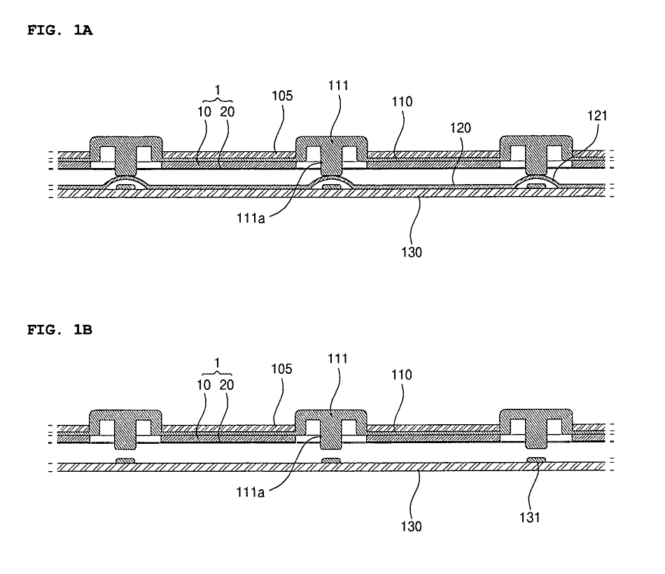

As illustrated in FIGS. 1A, 1B, 5, and 6, a backlight pad for a keypad assembly according to an embodiment of the present invention, for example, is a light emitting component which is installed between a keypad 110 and a substrate 130 in a keypad assembly 110 that forms an operation panel of an operation appliance such as a remote controller 101 or a mobile phone 103 to provide light to button portions 111 of the keypad 110, and thus the backlight pad 1 facilitates a button operation of the keypad even at night or in an environment having insufficient illumination. Here, unexplained reference numeral 105 denotes a case of the operation appliance such as the remote controller 101 or the mobile phone 103.

On the substrate 130, a dome switch sheet 120 having dome switches 121 provided in positions that correspond to the button portions may be installed as shown in FIG. 1A, or contact sensors 131, for example, such as piezoelectric elements, may be installed in the positions that correspond to the button portions 111 as shown in FIG. 1B, instead of the dome switch sheet 120.

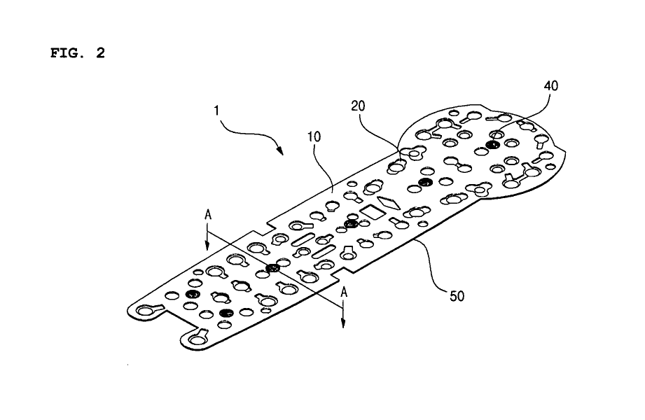

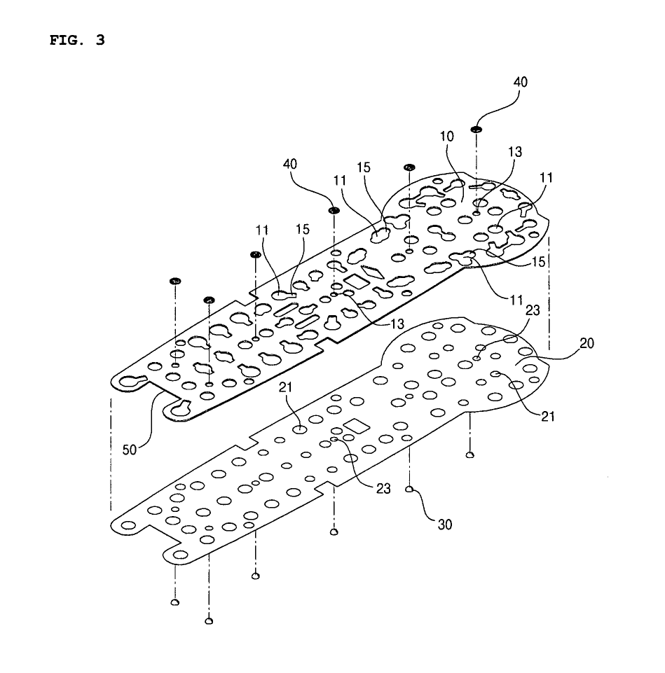

The backlight pad 1 for a keypad assembly according to an embodiment of the present invention is to minimize power consumption of a battery (not illustrated) through applying of a small number of light emitting elements 30 and to provide uniform light to all the button portions 111 of the keypad 110 regardless of a distance between the light emitting elements 110 and the button portions 111. As illustrated in FIGS. 2 to 4, the backlight pad 1 for a keypad assembly according to an embodiment of the present invention includes a light guide sheet 10 on which condensing holes 11 are penetratingly formed in positions that correspond to the button portions 111 of the keypad 110 and light emitting element installation holes 13 are arranged; a reflection sheet 20 attached to a lower surface of the light guide sheet 10 to prevent a loss of light through a lower portion of the light guide sheet 10, the reflection sheet 20 having through-holes 21 formed in positions that correspond to the condensing holes 11 of the light guide sheet 10 and light emitting element through-holes 23 arranged in positions that correspond to the light emitting element installation holes 13 of the light guide sheet 10; and light emitting elements 30 electrically connected to the substrate 130, and positioned in the light emitting element installation holes 13 through the light emitting element through-holes 23, respectively, to provide light to the light guide sheet 10.

Here, the light guide sheet 10 enables the button portions 111 of the keypad 110 to emit light by condensing the light emitted from the light emitting elements 30 into the condensing holes 11 and transferring the condensed light to the button portions 111 of the keypad 110. The light guide sheet 10 has a shape that corresponds to the keypad 110, and for example, is made in the form of a plate with a transparent synthetic resin material such as polymethylmethacrylate (PMMA).

The condensing holes 11 are penetratingly formed in the positions that correspond to the button portions 111 of the keypad 110 on the light guide sheet 10, and serve to enable rear projections 111a (see FIG. 1) of the button portions 111 of the keypad 110 for pressing the dome switches 121 or contact sensors 131 (see FIG. 1b) to pass through the condensing holes 11 and to enable the light transferred from the light emitting elements 30 to the light guide sheet 10 to be condensed and transferred to the button portions 111 of the keypad 110.

The principle of condensing the light in the condensing holes 11 is to use a difference between media through which the light is transferred. In the embodiment of the present invention, since the condensing holes 11, which are filled with air that is a relatively rarer medium, are formed on the light guide sheet 10, which is formed of a synthetic resin material that is a relatively denser medium, it is easy for the light transferred through the denser medium such as the light guide sheet 10 to be transferred into the condensing holes 11 filled with the rarer medium, but the light transferred into the condensing holes 11 is unable to be transferred to the light guide sheet 10 that is a denser medium to cause most of the light to be reflected and is confined in the condensing holes 11, resulting in that the light is condensed in the condensing holes 11.

Further, the light emitting element installation holes 13, which are arranged on the light guide sheet 10, form spaces in which the light emitting elements 30 for transferring the light to the light guide plate 10 are positioned. In order to provide uniform light to the condensing holes 11 even with a small number of light emitting elements 30, the light emitting element installation holes 13 may be arranged to be spaced apart from each other on the center line of the light guide sheet 10, may be symmetrically arranged on the basis of the center line of the light guide sheet 10, or part of the light emitting element installation holes 13 may be arranged to be spaced apart from each other on the center line of the light guide sheet 10, while the remaining part thereof may be symmetrically arranged on the basis of the center line of the light guide sheet 10.

On a lower surface of the light guide sheet 10, a reflection sheet 20 is attached. This reflection sheet 20 is to prevent a loss of the light through a lower portion of the light guide sheet 10, and is typically formed of a reflection sheet material.

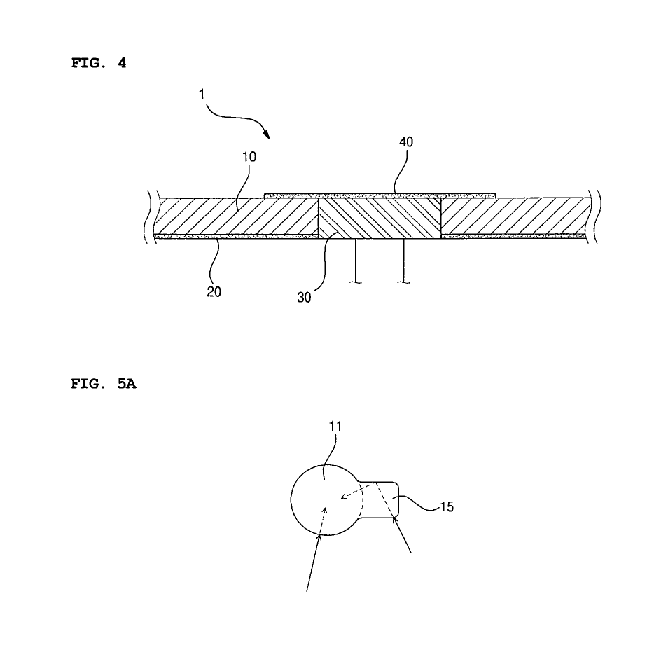

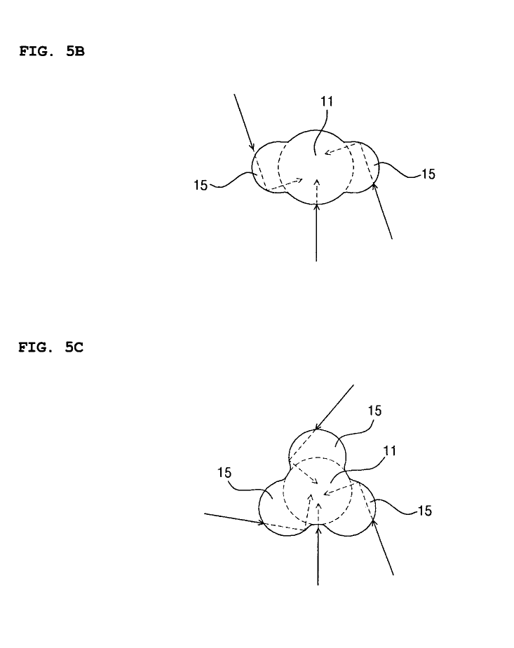

The most important constructional feature of the backlight pad 1 of the keypad assembly according to an embodiment of the present invention is that the side condensing holes 15 are additionally formed in a body with the condensing holes 11 that are formed in the regions except for the adjacent regions of the light emitting elements 30, and have the condensing areas which are wider than the areas of the condensing holes 11 that are formed in the adjacent regions of the light emitting elements 30, The side condensing holes 15 provide additional condensing areas to the condensing holes 11 which are formed in the regions except for the adjacent regions of the light emitting elements 30 and are far apart from the light emitting elements 30 to make less light reach the condensing holes 11 in comparison to the adjacent regions of the light emitting elements 30. Accordingly, as illustrated in FIGS. 5A to 5C, even the light that gets out of the condensing holes 11 is condensed into the condensing holes 11, and thus the same amount of light as that in the condensing holes which are formed in the adjacent regions of the light emitting elements can be condensed. In accordance with the distance or position with respect to the light emitting element 30, only one side condensing hole may be formed to project to one side around the condensing hole 11 as shown in FIG. 5A, two side condensing holes may be formed to project at an angle of 180° with each other around the condensing hole 11 as shown in FIG. 5B, three side condensing holes may be formed to project at an angle of 120° with one another around the condensing hole 11 as illustrated in FIG. 5C, or four side condensing holes may be formed to project at an angle of 90° with one another around the condensing hole 11 (not illustrated).

Through-holes 21 are formed on the reflection sheet 20. In the same manner as the condensing holes 11 of the light guide sheet 10, these through-holes 21 are formed in positions that correspond to the condensing holes 11 of the light guide sheet 10 to enable the rear projections 111a (see FIG. 1) of the button portions 111 of the keypad 110 for pressing the dome switches 121 or contact sensors 131 (see FIG. 1b) of the dome switch sheet 120 (see FIG. 1A) to pass through the through-holes 21.

In order to effectively perform the light interception through the reflection sheet 20, it is preferable that the through-holes 21 of the reflection sheet 20 have smaller areas than the corresponding condensing holes 11 of the light guide sheet 10.

Further, light emitting element installation holes 23 are formed on the reflection sheet 20. These light emitting element installation holes 23 are arranged in positions that correspond to the light emitting element installation holes 13 of the light guide sheet 10 so that the light emitting elements 30 pass through the reflection sheet 20 and are positioned in the light emitting element installation holes 13.

The light emitting elements 30 are positioned in the light emitting element installation holes 13 of the light guide sheet 10. These light emitting elements 30, which generate and provide light to the light guide sheet 10, may be LED elements which are electrically connected to the substrate 130 and emit light through reception of the power supply from the battery (not illustrated).

A side cover 50 is attached to a side surface of the edge of the light guide sheet 10 to prevent a loss of the light, which is transferred through the light guide sheet 10, through the side surface of the edge of the light guide sheet 10. The side cover 50 may be formed of a typical reflection sheet material that is attached to the side surface of the edge of the light guide sheet 10 or a reflection paint that is spread on the side surface of the edge of the light guide sheet 10.

Accordingly, in the case of the backlight pad 1 of the keypad assembly according to an embodiment of the present invention, since the side condensing holes 15 are additionally formed in a body with the condensing holes 11 that are formed in the regions except for the adjacent regions of the light emitting elements 30, and have the areas which are wider than the areas of the condensing holes 11 that are formed in the adjacent regions of the light emitting elements 30, the condensing holes 11 formed in the regions except for the adjacent regions of the light emitting elements 30 are far apart from the light emitting elements 30 to make less light reach the condensing holes 11 in comparison to the adjacent regions of the light emitting elements 30, whereas the condensing areas are increased due to the forming of the side condensing holes 15, and even the light that gets out of the condensing holes 11 is condensed into the condensing holes 11.

In the case of the backlight pad 1 of the keypad assembly according to an embodiment of the present invention, by the action of the side condensing holes 15, the same amount of light as that in the condensing holes 11 which are formed in the adjacent regions of the light emitting elements 30 can be condensed in the condensing holes 11 which are formed in the regions except for the adjacent regions of the light emitting elements 30, and then are transferred to the button portions 111 of the keypad 110. Accordingly, uniform light can be provided to all the button portions 111 of the keypad 110 regardless of the distance between the light emitting elements 30 and the button portion 111, and thus a smaller number of light emitting elements 30 can be applied to minimize the power consumption of a battery.

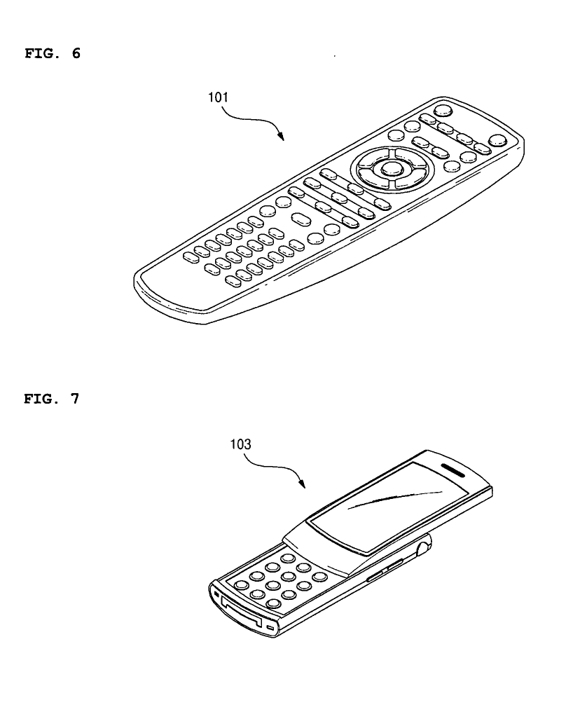

Further, the backlight pad 1 for the keypad assembly according to an embodiment of the present invention may be installed between the keypad 110 and the substrate 130 in the keypad assembly 110 that forms the operation panel of the remote controller 101 as shown in FIG. 6, or may be installed between the keypad 110 and the substrate 130 in the keypad assembly 110 that forms the operation panel of the mobile phone 103 as shown in FIG. 7.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A backlight pad for a keypad assembly that is installed between a keypad and a substrate in the keypad assembly to provide light to button portions of the keypad, the backlight pad comprising:
a light guide sheet on which condensing holes are penetratingly formed in positions that correspond to the button portions of the keypad and light emitting element installation holes are arranged;
a reflection sheet attached to a lower surface of the light guide sheet to prevent a loss of light through a lower portion of the light guide sheet, the reflection sheet having through-holes formed in positions that correspond to the condensing holes of the light guide sheet and light emitting element through-holes arranged in positions that correspond to the light emitting element installation holes of the light guide sheet; and
light emitting elements electrically connected to the substrate, and positioned in the light emitting element installation holes through the light emitting element through-holes, respectively, to provide light to the light guide sheet;
wherein side condensing holes are additionally formed in a body with the condensing holes that are formed in regions except for adjacent regions of the light emitting elements, and have areas which are wider than areas of the condensing holes that are formed in the adjacent regions of the light emitting elements.

2. The backlight pad for a keypad assembly according to claim 1, further comprising light emitting element covers attached to the light emitting element installation holes of the light guide sheets to make the light from the light emitting elements be transferred to the light guide sheet.

3. The backlight pad for a keypad assembly according to claim 2, further comprising a side cover attached to a side surface of the edge of the light guide sheet to prevent a loss of the light, which is transferred through the light guide sheet, through the side surface of the edge of the light guide sheet.

4. The backlight pad for a keypad assembly according to claim 1, wherein the light emitting elements are arranged to be spaced apart from each other on the center line of the light guide sheet, are symmetrically arranged on the basis of the center line of the light guide sheet, or part of the light emitting elements is arranged to be spaced apart from each other on the center line of the light guide sheet and the remaining part thereof is symmetrically arranged on the basis of the center line of the light guide sheet.

5. The backlight pad for a keypad assembly according to claim 2, wherein the light emitting elements are arranged to be spaced apart from each other on the center line of the light guide sheet, are symmetrically arranged on the basis of the center line of the light guide sheet, or part of the light emitting elements is arranged to be spaced apart from each other on the center line of the light guide sheet and the remaining part thereof is symmetrically arranged on the basis of the center line of the light guide sheet.

6. The backlight pad for a keypad assembly according to claim 3, wherein the light emitting elements are arranged to be spaced apart from each other on the center line of the light guide sheet, are symmetrically arranged on the basis of the center line of the light guide sheet, or part of the light emitting elements is arranged to be spaced apart from each other on the center line of the light guide sheet and the remaining part thereof is symmetrically arranged on the basis of the center line of the light guide sheet.

7. The backlight pad for a keypad assembly according to claim 1, wherein only one side condensing hole is formed to project to one side around the condensing hole, two side condensing holes are formed to project at an angle of 180° with each other around the condensing hole, three side condensing holes are formed to project at an angle of 120° with one another around the condensing hole, or four side condensing holes are formed to project at an angle of 90° with one another around the condensing hole.

8. The backlight pad for a keypad assembly according to claim 2, wherein only one side condensing hole is formed to project to one side around the condensing hole, two side condensing holes are formed to project at an angle of 180° with each other around the condensing hole, three side condensing holes are formed to project at an angle of 120° with one another around the condensing hole, or four side condensing holes are formed to project at an angle of 90° with one another around the condensing hole.

9. The backlight pad for a keypad assembly according to claim 3, wherein only one side condensing hole is formed to project to one side around the condensing hole, two side condensing holes are formed to project at an angle of 180° with each other around the condensing hole, three side condensing holes are formed to project at an angle of 120° with one another around the condensing hole, or four side condensing holes are formed to project at an angle of 90° with one another around the condensing hole.

10. The backlight pad for a keypad assembly according to claim 1, wherein the through-hole of the reflection sheet has an area that is smaller than an area of the condensing hole of the light guide sheet.

11. The backlight pad for a keypad assembly according to claim 2, wherein the through-hole of the reflection sheet has an area that is smaller than an area of the condensing hole of the light guide sheet.

12. The backlight pad for a keypad assembly according to claim 3, wherein the through-hole of the reflection sheet has an area that is smaller than an area of the condensing hole of the light guide sheet.
